(19) United States
(12) Patent Application Publication
(10) Pub. No.: US 2003/0133754 A1
(43) Pub. Date: Jul. 17, 2003

(54) Modular fish ladder

(76) Inventor: Kevin J. Barnett, Naramata (CA)

Correspondence Address: John Elnitski, 225A Snowbird Lane, Bellefonte, PA, 16823, US

(21) Appl. No.: 10/042,269

(22) Filed: Jan. 11, 2002

(51) Int. Cl. E02B 8/08; A01K 61/00

(52) U.S. Cl. 405/82; 405/81; 119/219

(57) ABSTRACT

A fish ladder is used at a water way outlet of a water way which is higher than a body of water. The fish ladder reduces jump heights for fish entering the water way outlet from the body of water. The fish ladder is a series of tiers installed below and up to the water way outlet, thereby reducing the jump height between the water way outlet and the body of water. The fish ladder is a modular design which can be altered to fit the needs of a particular site based on the size of the body of water, jump height and water way outlet size. The height, length and width of the tiers, as well as the number of tiers, is specific to the site of the installation.

### BACKGROUND

The present invention generally relates to fish ladders to allow fish to migrate upstream past man made obstacles. More specifically, the invention relates to a fish ladder for use in steams at an outlet of a culvert pipe. Whereby, the culvert pipe is positioned in the stream to allow the building of roads over streams, without disturbing the flow of water in the stream.

With increasing population, there is a need to build in areas near fish-bearing bodies of water, such as streams where fish migrate. Culvert pipes are used as man made water ways to allow building over the streams without disturbing the flow of water in the stream. The culvert pipe has an inlet and outlet, which is defined by the flow of the stream. The outlet of the culvert pipe being on the downstream side of the culvert pipe and act as a water way outlet into the stream. Many of the culvert outlets are positioned higher than the stream, whereby the water drops off from the culvert pipe into the stream. The drop from culvert pipes affect the upstream migration of fish. Especially, fish migrating upstream to spawn. The migrating fish cannot get up and into the culvert pipe to continue on upstream, due to the jump height required to enter into the culvert outlet of the culvert pipe. Also, stream velocity usually increases through the culvert pipe, thereby making it more difficult for the fish to swim through the water exiting the culvert outlet.

There are many systems on the market to aid fish who encounter man made obstacles in the flow of rivers and streams. Most of these systems are elaborate, expensive and are designed to meet the needs of dams and other large building projects. There is a need for a system to allow fish to jump into the culvert outlet which is simple to employ, adjustable to meet the needs of the jump height, and inexpensive to manufacture and maintain.

It is an object of the present invention to provide a system to aid fish in traversing man made obstacles that is simple to employ, adjustable to meet the needs of the jump height, and inexpensive to manufacture and maintain.

### SUMMARY OF THE INVENTION

A fish ladder system for installation in a body of water and under a water way outlet to aid fish in jumping into the water way outlet. The fish ladder includes at least one tier having at least one continuous side and an open top. The side including a top and a bottom, whereby the top of the side forms the open top of the at least one tier. The side of said at least one tier forming an enclosed area under the water way outlet to receive water from the water way outlet. The open top of the tier being higher then the body of water to bridge jump height between the body of water and water way outlet.

### BRIEF DESCRIPTION OF THE DRAWINGS

FIG. 1 is a front perspective view of an installed fish ladder according to present invention;

FIG. 2 is a front perspective view of a two tier system according to present invention;

FIG. 3 is a side exploded view of a two tier system according to present invention;

FIG. 4 is a side view of an installed two tier system according to present invention;

FIG. 5 is a front perspective view of an installed two tier system according to present invention;

FIG. 6 is a top view of an installed three tier system according to present invention;

FIG. 7 is a side view of an installed three tier system according to present invention; and

FIG. 8 is a side schematic view of water flow in an installed two tier system according to present invention.

### DETAILED DESCRIPTION

The present invention is a fish ladder 10. The fish ladder 10 is used at a water way outlet of a water way which is higher than a body of water. The fish ladder 10 reduces jump height for fish entering the water way outlet from the body of water. The fish ladder 10 is easy to install and less expensive to manufacture and maintain, as compared to current methodology. The fish ladder 10 acts to reduce the velocity of the water flowing from the water way outlet. The fish ladder 10 also uses minimal area, thereby limiting habitat disturbances, as compared to the current methodology. The fish ladder 10 is a series of tiers installed below and up to the water way outlet, thereby reducing the jump height between the water way outlet and the body of water. The fish ladder 10 is a modular design which can be altered to fit the needs of a particular site based on the size of the body of water, jump height and water way outlet size. The height 12, length 14 and width 16 of the tiers, as well as the number of tiers, is specific to the site of the installation.

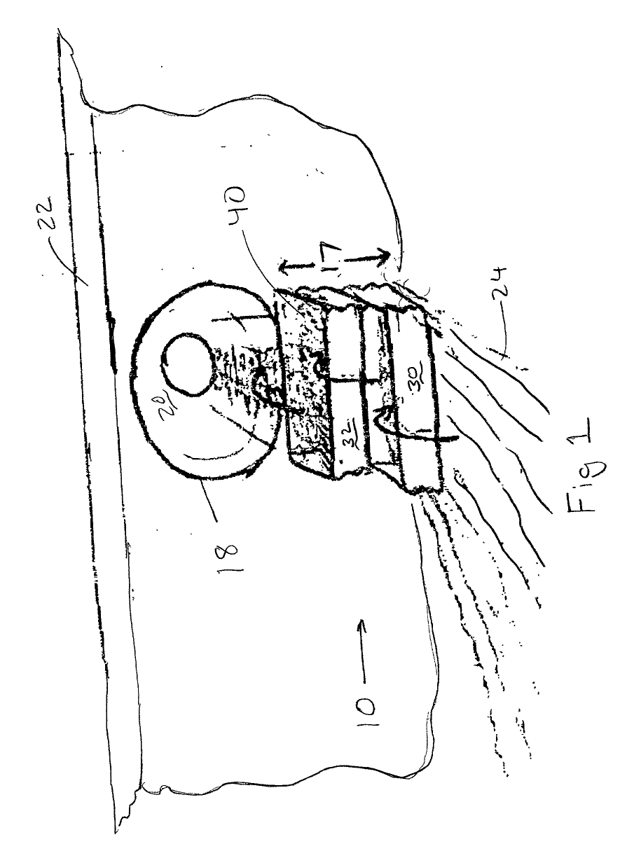

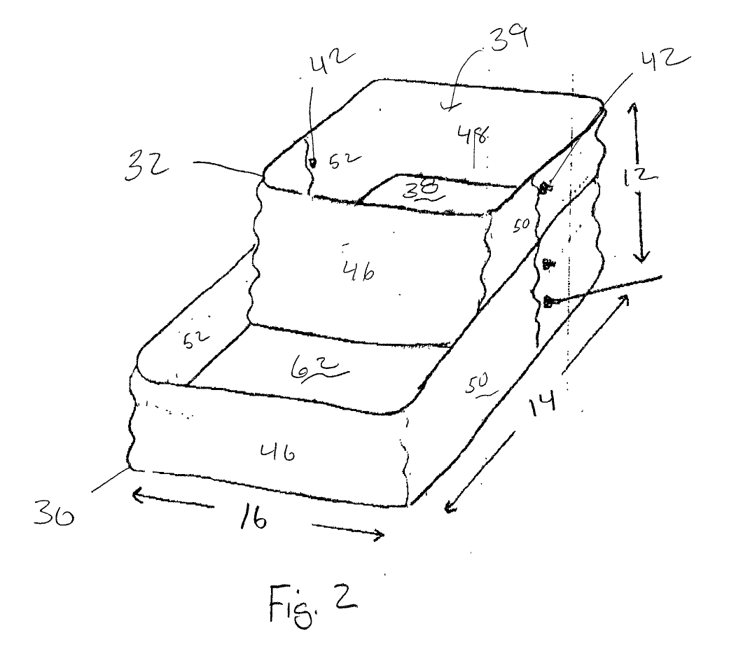

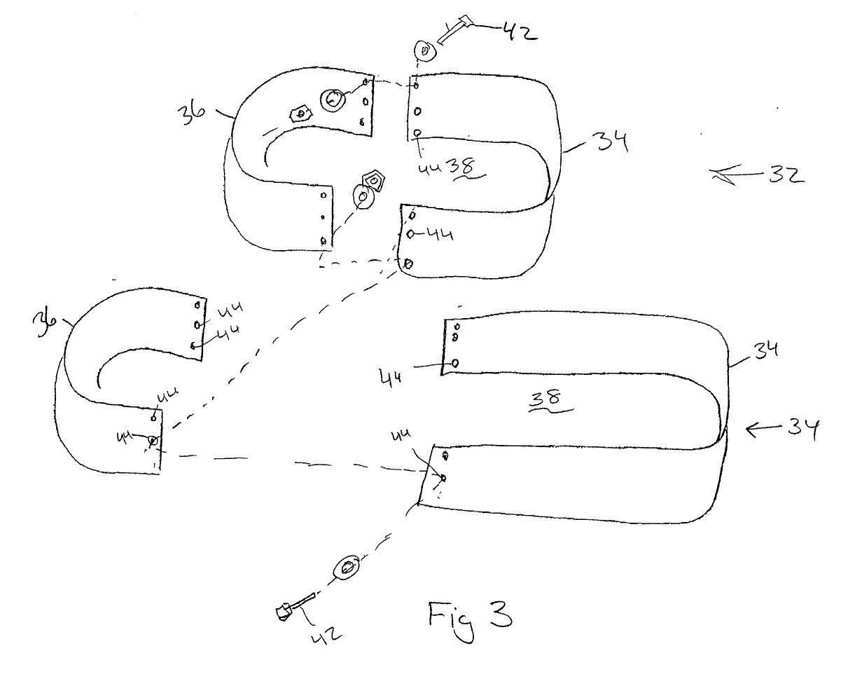

FIG. 1 shows the fish ladder 10 positioned at a culvert outlet 18 of a culvert pipe 20. The culvert pipe 20 is shown installed under a roadway 22 to allow a stream 24 to flow under the roadway 22. The fish ladder 10 in FIG. 1 includes two tiers, shown as tier one 30 and tier two 32. FIG. 1 is shown as an example, but the fish ladder 10 could also be one tier or three or more tiers. The number of tiers is dependent upon the jump height 17 between the culvert outlet 18 and the stream 24, size of the culvert outlet 18 and jumping ability of the fish that use the stream 24. FIG. 2 shows tiers one 30 and two 32 assembled. FIG. 3 shows an exploded view of the tiers one 30 and two 32. As shown in FIG. 3, each of tiers one 30 and two 32 include a front piece 34 and a rear piece 36, which are assembled together and defined an enclosed area 38 with an open top 39 to receive water 40. Each of the tiers one 30 and two 32 are made from a non-corrosive material, such galvanized steel to withstand exposure to natural elements of the outdoors. Tiers one 30 and two 32 are assembled using fasteners 42 and fastener holes 44. The fasteners 42 should be able to resist corrosion from the natural elements of the outdoors, such as stainless steel nuts, washers and bolts. The length 14 of a tier can be adjusted by the positioning the front and rear pieces 34, 36 of the tier in relation to each other. The fastener holes 44 can be drilled at the site to allow for positioning of the front and rear pieces 34, 36 of the tier and ensure a precise fit at the culvert outlet 18.

Tiers one 30 and two 32 are defined by the height 12, length 14 and width 16. The height 12 and width 16 forms the front side 46 and the rear side 48 of tiers one 30 and two 32. The height 12 and length 14 form the left side 50 and the right side 52 of tiers one 30 and two 32. The front, rear, left and right sides 46, 48, 50, 52 of tiers one 30 and two 32 together form the enclosed area 38 to receive water 40 from the culvert outlet 18. As shown in FIG. 2, tier two 32 occupies some of the enclosed area 38 of tier one 30. The width 16 of tiers one 30 and two 32 usually is at least the maximum width of the stream flow from the culvert outlet 18. The height 12 and length 14 of tiers one 30 and two 32 are defined by the height 54 from the stream bed 56 to the culvert outlet 18 and could be any combination that allows positioning of tier two 32 under the culvert outlet 18. The four sides 46, 48, 50, 52 of the tiers are shown to form a rectangular shaped enclosed area 38. It is conceivable that the sides 46, 48, 50, 52 of the tiers could form any type of geometric shape, as long as the sides 46, 48, 50, 52 form the enclosed area 38 to receive the water 40. For example, there could only be one continuous side which forms a circular enclosed area or three sides which forms a triangular enclosed area (not shown). As with the tiers shown in FIGS. 1-3, different geometric shapes could be broken down into more than one piece to reduce transport size. As shown in FIGS. 1-3, tier two 32 is assemble into tier one 30 using the fasteners 42 and common fastener holes 44. As stated before, only one tier could be used or additional tiers could be used, such as a third tier inside of tier two 32, depending on jump height 17 and height 54 from the stream bed 56 to the culvert outlet 18. A good height between the open top 39 of a tier and the next open top 39 of a tier or the culvert outlet 18 is about fifteen centimeters (15 cm) or less.

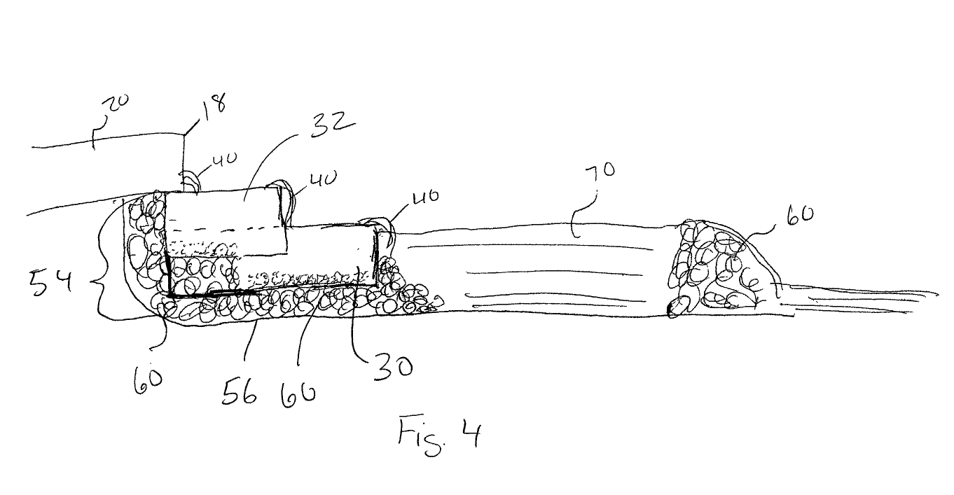

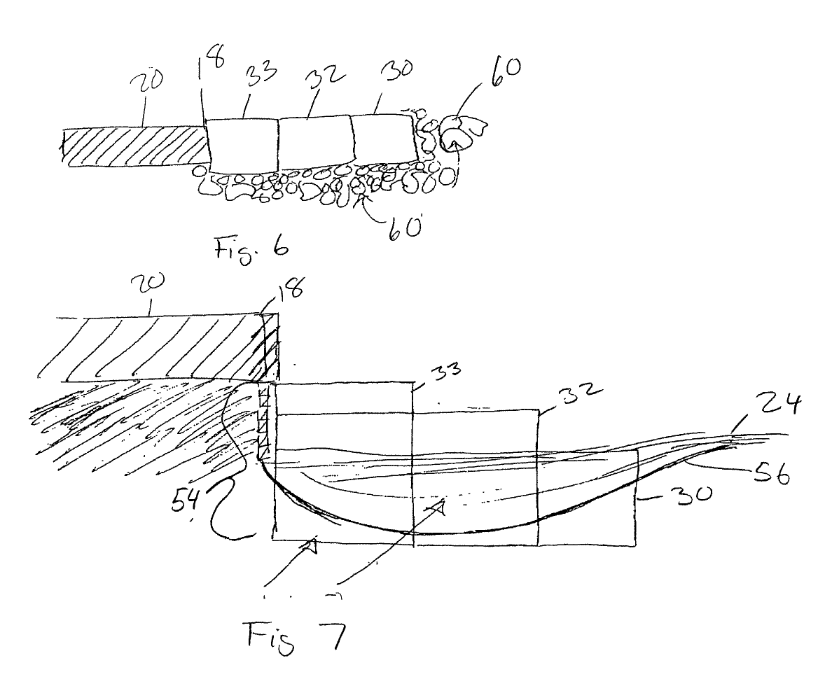

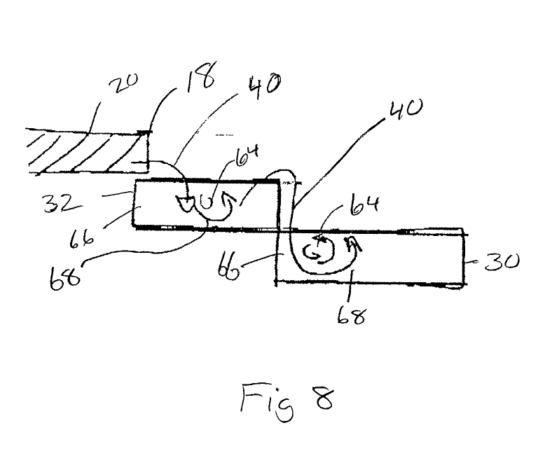

FIGS. 1, and 4-5 show assembled tiers one 30 and two 32 installed in the stream bed 56, such that tier two 32 is under the culvert outlet 18. FIGS. 6-7 show tiers one 30, two 32 and an additional tier three 33 installed as a three tier system in the stream bed 56, such that tier three is under the culvert outlet 18. Rocks 60 are positioned and packed around the assembled tiers to hold the assembled tiers in position, as shown in FIGS. 4-6. FIG. 7 shows the three tier system installed, whereby tier one 30 is buried in the stream bed 56 to aid in retaining the fish ladder 10 in position. FIG. 7 shows that the depth of stream 24 needs to be considered when determining how many tiers should be used and what the height 12 and length 14 of the tiers should be chosen. FIG. 6 shows rocks 60 packed around tiers one 30, two 32 and three 33 to retain the fish ladder 10 in position.

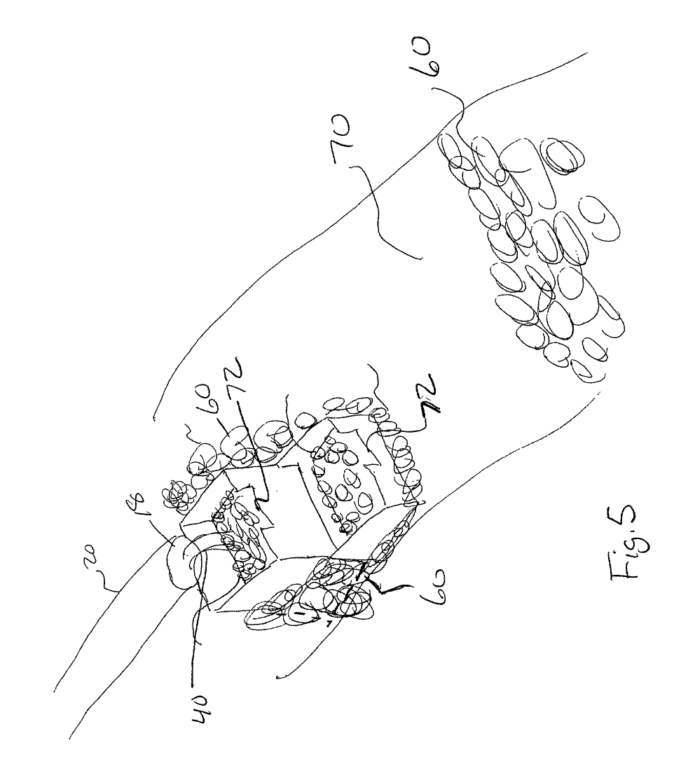

As an example, the two tier system will be used to describe the operation of the fish ladder 10. FIGS. 1, 4-5 show the water 40 of the stream 24 flowing through the fish ladder 10. Once the fish ladder 10 is installed, the water 40 flows from the culvert outlet 18 and into the enclosed area 38 of tier two 32, filling the enclosed area 38 of tier two 32. Once tier two 32 is full, the water 40 begins flowing over the front of tier two 32 and into the unoccupied area 62 of the enclosed area 38 of tier one 30, filling the unoccupied area 62 of the enclosed area 38 of tier one 30. Once tier one 30 is full, the water 40 begins flowing over the front of tier one 30 and into the stream 24. The flowing of water 40 from tier to tier aids in reducing the velocity of the water 40 exiting the culvert outlet 18. As the water 40 drops from the culvert outlet 18 and tiers to the tier below, the water 40 creates a turbulent reaction 64 in the water 40 of the tier below. This turbulent reaction 64 is shown in FIG. 8. As the water 40 drops into the tier below, near the rear 66 of the enclosed area 38 filled with water 40, the water 40 towards the middle to front 68 of the tier below rotates from the bottom to the top of the tier. The turbulent reaction 64 of the water 40 in the tier below actually aids the fish in jumping, as it tends to propel and lift the fish toward the tier or culvert outlet 18 above, as the fish initiate the jump. FIGS. 4-5 show additional variations which can be added to the fish ladder 10 and the installation of the fish ladder 10. FIGS. 4-5 show a pool 70, which is created before tier one 30. The pool 70 is shown created by piling rocks 60 in front of tier one 30, which fills from tier one 30 and overflows into the stream 24. The pool 70 acts as a staging area for the fish to begin jumping, which can be much larger than the tiers. FIG. 5 also shows a notch 72 in the top of the front sides 46 of each of the tiers. The notch 72 allows the water 40 to flow from one tier to the next, without water 40 spilling over the right and left sides 52, 50 of the tiers. Another method to alleviate water 40 spilling over the right and left sides 52, 50 of the tiers is to install the tiers with the top of the front sides 46 slightly lower than the top of the rear sides 48.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A fish ladder system, for installation in a body of water and under a water way outlet to aid fish in jumping into the water way outlet, comprising:
at least one tier having at least one continuous side and an open top, said side having a top and a bottom, said top of said side forming said open top of said at least one tier, said side of said at least one tier forming an enclosed area under the water way outlet to receive water from the water way outlet, said open top of said tier higher then the body of water to bridge jump height between the body of water and water way outlet.

2. The fish ladder system of claim 1, wherein said at least one tier includes a plurality of sides forming said enclosed area with said open top.

3. The fish ladder system of claim 1, wherein said at least one tier includes a front and a rear, said rear being nearest to the water way outlet and wherein said front includes a notch at said top of said at least one continuous side to release water from said at least one tier into said body of water.

4. The fish ladder system of claim 1, wherein said at least one tier includes four sides forming a rectangular shape for said enclosed area with said open top.

5. The fish ladder system of claim 1, wherein said at least one tier includes two pieces fastened together to form said at least one continuous side of said at least one tier.

6. The fish ladder system of claim 1, wherein a height between said top of said at least one tier and the body of water is no greater than 15 centimeters; and wherein a height between said top of said at least one tier and the water way outlet is no greater than fifteen centimeters (15 cm).

7. The fish ladder system of claim 1, wherein rocks are packed around said at least one tier to retain said at least one tier in place in the body of water.

8. A fish ladder system, for installation in a body of water and under a water way outlet to aid fish in jumping into the water way outlet, comprising:
at least two tiers nested together in succession, each of said tiers having at least one continuous side and an open top, said side having a top and a bottom, said top of said side forming said open top of each of said tiers, and said side of each of said tiers forming an enclosed area;
a first tier of said at least two tiers in said succession for installing first in the body water and being larger than succeeding tiers of said at least two tiers, each of said succeeding tiers nested in said enclosed area of a larger succeeding tier that comes before each of said succeeding tiers, each said open top of each of said succeeding tier being higher than said open top of said succeeding tier that comes before each of said succeeding tiers, and wherein there remains an unoccupied area of said enclosed area in each of said succeeding tiers to receive water from said succeeding tier nested inside that tier; and
a final tier in said succession of said at least two tiers installed under the water way outlet to receive water from the water way outlet, wherein the water spills over downward into each succeeding tier before that tier until the water finally spills into the body of water, said open top of each of said tiers being higher then said tier before to bridge jump height between the body of water and water way outlet.

9. The fish ladder system of claim 8, wherein each of said at least two tiers includes a plurality of sides forming said enclosed area with said open top.

10. The fish ladder system of claim 8, wherein each of said at least two tiers includes a front and a rear, said rear being nearest to the water way outlet and wherein said front includes a notch at said top of said at least one continuous side to release water from each of said at least two tiers into said succeeding tier below and into said body of water.

11. The fish ladder system of claim 8, wherein each of said at least two tiers includes four sides forming a rectangular shape for said enclosed area with said open top.

12. The fish ladder system of claim 8, wherein each of said at least two tiers includes two pieces fastened together to form said at least one continuous side of each of said at least two tiers.

13. The fish ladder system of claim 8, wherein a height between said top of each of said tiers is no greater than fifteen centimeters (15 cm); wherein a height between said top of said first tier and the body of water is no greater than fifteen centimeters (15 cm); and wherein a height between said top of said final tier and the water way outlet is no greater than fifteen centimeters (15 cm).

14. The fish ladder system of claim 8, wherein rocks are packed around said succeeding tiers to retain said fish ladder system in place in the body of water.

15. A fish ladder system, for installation in a body of water and under a water way outlet to aid fish in jumping into the water way outlet, comprising:
at least one tier in a shape of a rectangle having a length, width and height, said at least one tier having front, rear, left and right sides, said sides having a top and bottom, said length and height defining said left and right sides, said width and height defining said front and rear sides; and
said top of said sides forming an open top of said at least one tier, said sides of said at least one tier forming an enclosed area under the water way outlet to receive water from the water way outlet, said open top of said at least one tier higher then the body of water to bridge jump height between the body of water and a water way outlet.

16. The fish ladder system of claim 15, wherein said at least one tier is divided into a front piece and a rear piece along said length and is fastened together to form said at least one tier.

17. The fish ladder system of claim 16, further including fastening holes in said right and left side of said front piece and fastening holes in said right and left side of said rear piece which align with said fastenings holes of said front piece.

18. The fish ladder system of claim 15, wherein said at least one tier includes a front and a rear, said rear being nearest to the water way outlet and wherein said front includes a notch at said top of said at least one continuous side to release water from said at least one tier into said body of water.

19. The fish ladder system of claim 15,
wherein there are at least two tiers nested together in succession;
a first tier of said at least two tiers in said succession for installing first in the body water and being larger than succeeding tiers of said at least two tiers, each of said succeeding tiers nested in said enclosed area of a larger succeeding tier that comes before each of said succeeding tiers, each said open top of each of said succeeding tier being higher than said open top of said succeeding tier that comes before each of said succeeding tiers, and wherein there remains an unoccupied area of said enclosed area in each of said succeeding tiers to receive water from said succeeding tier nested inside that tier; and
a final tier in said succession of said at least two tiers installed under the water way outlet to receive water from the water way outlet, wherein the water spills over downward into each succeeding tier before that tier until the water finally spills into the body of water, said open top of each of said tiers being higher then said tier before to bridge jump height between the body of water and water way outlet.

20. The fish ladder system of claim 19, wherein each of said tiers is divided into a front piece and a rear piece along said length and is fastened together to form each of said tiers.

21. The fish ladder system of claim 20, further including fastening holes in said right and left side of said front piece and fastening holes in said right and left side of said rear piece which align with said fastenings holes of said front piece.

22. The fish ladder system of claim 19, wherein a height between said top of each of said tiers is no greater than fifteen centimeters (15 cm); wherein a height between said top of said first tier and the body of water is no greater than fifteen centimeters (15 cm); and wherein a height between said top of said final tier and the water way outlet is no greater than fifteen centimeters (15 cm).
